(19) United States
(12) Patent Application Publication
(10) Pub. No.: US 2008/0070199 A1
(43) Pub. Date: Mar. 20, 2008

(54) Coloring book composed of digital images converted to black and white outlines

(76) Inventor: Sandra R. Sommer, St. Petersburg, FL (US)

Correspondence Address: SANDRA R. SOMMER, 3980 56 AVENUE NORTH, ST. PETERSBURG, FL, 33714, US

(21) Appl. No.: 11/467,868

(22) Filed: Aug. 28, 2006

(51) Int. Cl. G09B 11/10

(52) U.S. Cl. 434/84

(57) ABSTRACT

A coloring book is provided, especially for children, having a cover and a content including several pages, on which pictures and text are found. This book is individualized, in that the coloring pages are converted jpeg photographs of grandparents (also can be applied to extended family and friends, pets, or other similar groupings) submitted by customers and converted into black and white coloring page images. The text will be simple phrase describing the activity in the photograph. The primary purpose of this coloring book is to provide a medium through which grandparents may maintain a relationship with grandchildren when visiting is difficult or impossible by rendering a photographic representation of the client(s) in coloring book pages.

### BACKGROUND OF THE INVENTION

The invention concerns a coloring book, designed especially for grandparents to give to their grandchildren, having a cover and contents consisting of a plurality of pages containing coloring pages and text positioned on the pages, wherein the customer supplies 12 jpeg digital pictures which will be converted into black and white computer-generated replicas; simple text headlines on each page which describe the image, all bound together into one coloring book suitable for coloring by a child.

Long distance grandparenting is becoming more and more prevalent in today'd mobile society. Grandparents rarely get to visit their little loves and need a venue for keeping their memories alive in the far-away child's mind. The primary purpose of this coloring book is to provide a medium through which grandparents may maintain a relationship with grandchildren when visiting is difficult or impossible by rendering a photographic representation of the client(s) in coloring book pages.

By providing a kid-friendly medium of coloring pages of images of the grandparents, the grandchildren will be more inclined to remember their loving grandparents when personal visits are made. In addition, seeing grandparents in their normal settings will help the children see their grandparents as real people, not just disembodied voices on the telephone or words on paper.

### SUMMARY OF THE INVENTION

Coloring pages containing computer-generated images converted from jpeg pictures submitted by customers for individualization in this medium. Simple text describing the image will be added to each page. All pages and a cover will be bound by spiral binding processes.

Since this concept could easily apply to other relatives, friends, or pets, it is understood that this invention is not limited to the particular embodiment(s) disclosed, but it is intended to cover modifications within the spirit and scope of the present invention.

What is claimed is:

1. A coloring book, designed especially for grandparents to give to their grandchildren, comprising of a cover and contents consisting of a plurality of pages containing coloring pages and text positioned on the pages, wherein the customer supplies 12 jpeg digital pictures which will be converted into black and white computer-generated replicas; simple text headlines on each page which describe the image, all bound together into one coloring book suitable for coloring by a child.
